(19) United States
(12) Patent Application Publication
(10) Pub. No.: US 2012/0067674 A1
(43) Pub. Date: Mar. 22, 2012

(54) ELEVATOR WITH AN ELEVATOR CAGE AND A COUNTERWEIGHT

(76) Inventors: Benoît Légeret, Sao Paulo (BR); Danilo Peric, Luzern (CH); Urs Baumgartner, Merenschwand (CH)

(21) Appl. No.: 13/234,486

(22) Filed: Sep. 16, 2011

(30) Foreign Application Priority Data
Sep. 17, 2010 (EP) 10177409.9

(51) Int. Cl. B66B 17/12

(52) U.S. Cl. 187/404

(57) ABSTRACT

An elevator cage is arranged in an elevator shaft at one end of a support means, and a counterweight is arranged at the other end of the support means. If the elevator cage is at the top in the elevator shaft, the support means length and the weight of the support means are large on the counterweight side. If the elevator cage is at the bottom in the elevator shaft, the support means length and the weight of the support means are large on the cage side. A first balancing element and a second balancing element are provided as equalization for the weight shift from the counterweight side to the cage side.

### CROSS-REFERENCE TO RELATED APPLICATION

This application claims priority to European Patent No. 10177409.9, filed Sep. 17, 2010, which is incorporated herein by reference.

### FIELD

The disclosure relates to an elevator with a support means and balancing elements.

### BACKGROUND

An elevator has become known from the patent specification CH 403 225 with equipment for balancing the weight of a support means. The support means is guided over a drive pulley, which in turn is drivable by means of an elevator drive. An elevator cage is arranged at one end of the support means and a counterweight is arranged at the other end of the support means. The elevator cage and the counterweight are movable by way of the support means in opposite directions in an elevator shaft, wherein the elevator cage serves different stories.

If the elevator cage is positioned at the top of the elevator shaft, the support means length and the weight of the support means are large on the counterweight side. If the elevator cage is disposed at the bottom of the elevator shaft, the support means length and the weight of the support means are large on the cage side. Provided as compensation for the weight displacement from the counterweight side to the cage side is a compensating element, which is arranged at one end at the elevator cage and at the other end at the counterweight. If, for example, the support means length is large on the counterweight side, the balancing element length is small on the counterweight side and large on the cage side. Equalization of or compensation for the weight displacement on the part of the support means is provided by the balancing element acting in the opposite direction. The drive torque, the brake torque and the traction at the drive pulley can be optimized by the weight compensation.

An elevator installation has become known from the specification US 2007/0131489, in which the balancing element is not arranged between the elevator cage and the counterweight as in the case in of CH 403 225, but a first balancing element is arranged between the elevator cage and a shaft wall and a second balancing element is arranged between the counterweight and a shaft wall, wherein the end of the respective balancing element at the shaft side is arranged at half the height of the elevator shaft.

An elevator installation has become known from the specification EP 0 653 372 A2, in which two balancing elements act on the elevator cage, and the ends thereof are arranged at the shaft wall. A further balancing element is provided between the counterweight and the shaft wall.

An elevator installation has become known from U.S. Pat. No. 3,810,529 in which two chains, guided to be parallel and led over deflecting rollers, are provided between the elevator cage and the counterweight as balancing elements, wherein the gantry and thus the chains are biased by means of springs.

The balancing elements known from the prior art generally form loops with large radii and generally require a considerable amount of space in the shaft.

### SUMMARY

At least some embodiments described herein disclose equipment for equalizing the weight of support means and the balancing elements. At least some embodiments require little space in the shaft.

In at least some embodiments, the loops of the balancing elements have small radii and thus require a shaft pit with merely a small pit depth. Moreover, the suspension points at the elevator shaft or at the counterweight for the compensating elements are not arranged centrally, but can be shifted symmetrically with respect to the center of gravity to the edge of the cage projection or the counterweight projection. In that case it can be important that the balancing forces multiplied by the spacing thereof from the center of gravity are equal. A better balancing of the elevator cage and the counterweight can thereby arise. Moreover, the arrangement of shaft equipment such as, for example, buffers in the shaft pit, can be simplified, and forces on the guide shoes, particularly on the cage guide shoes, can be minimized. The hanging cable supplying the elevator cage with energy and control signals can also be used as a balancing element. In some cases, cost savings are also possible by the proposed equipment.

### BRIEF DESCRIPTION OF THE DRAWINGS

The present disclosure is explained in more detail by way of the accompanying figures, in which:

FIG. 1 shows an exemplary embodiment of an elevator with elevator cage, counterweight, support means and balancing elements,

FIG. 2 shows a side view of an exemplary embodiment of the elevator cage with balancing elements acting at the center of gravity or in symmetry with respect to the center of gravity,

FIGS. 3 and 4 show exemplary embodiments of an elevator cage and a counterweight in the projection with the balancing elements according to FIG. 2,

FIG. 5 shows the elevator according to FIG. 1 with the elevator cage and the counterweight and a 1:1 support means guidance in the center of an elevator shaft,

FIG. 6 shows the elevator according to FIG. 1 with the elevator cage at the bottom and the counterweight and a 1:1 support means guidance at the top of the elevator shaft,

FIG. 7 shows the elevator according to FIG. 1 with the elevator cage at the top and the counterweight and a 1:1 support means guidance at the bottom of the elevator shaft,

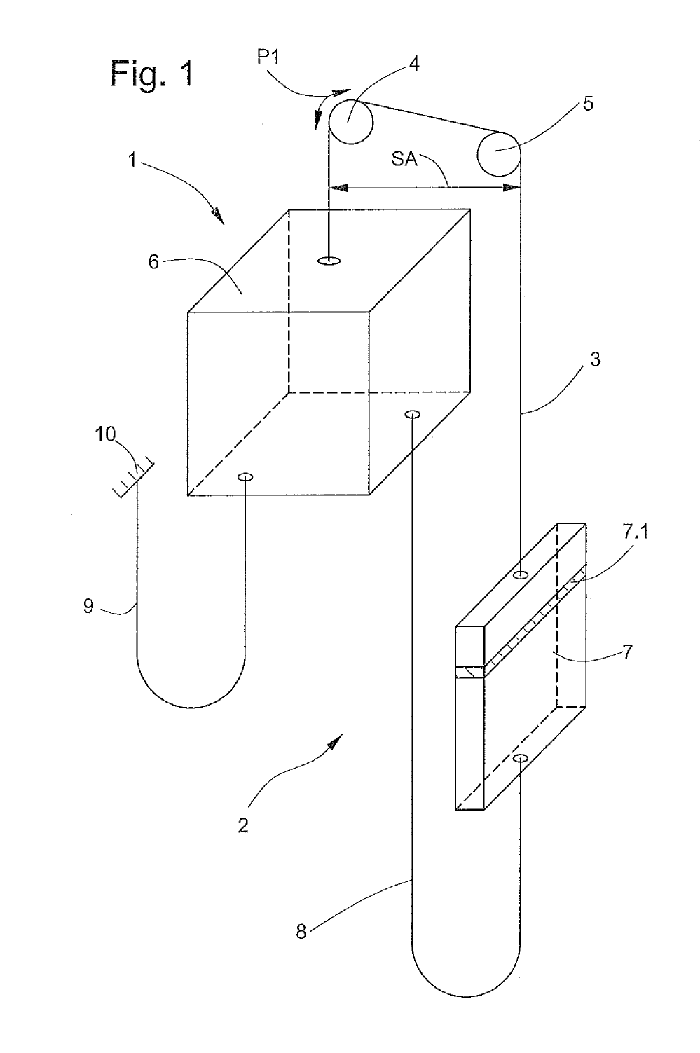

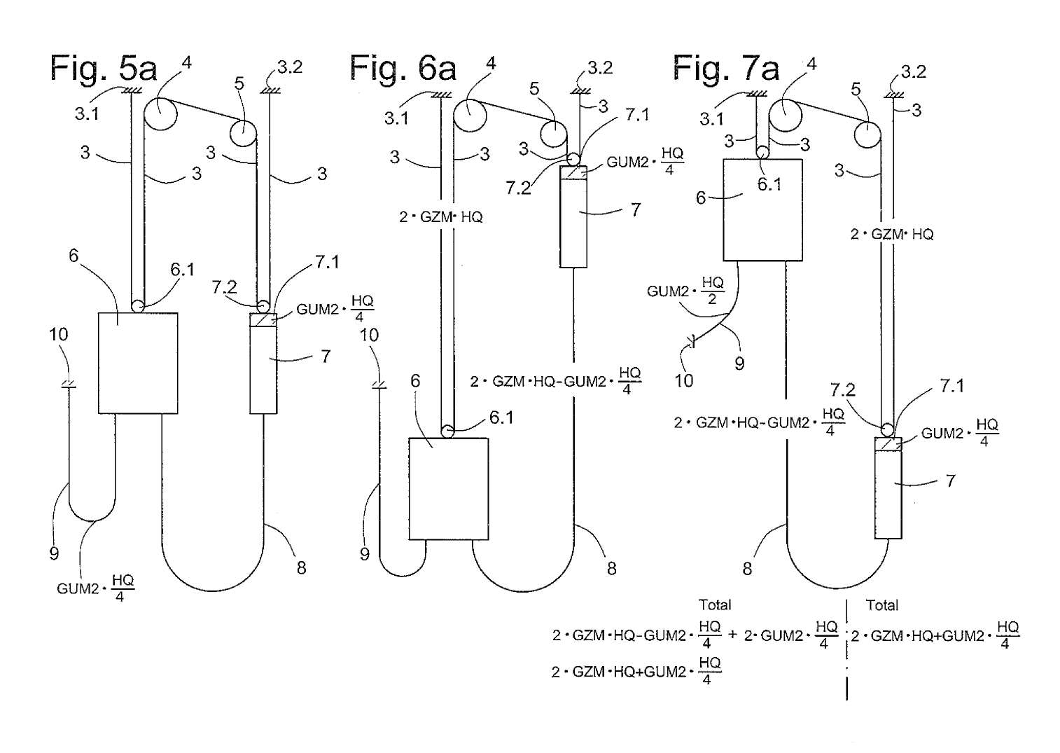

FIG. 5a shows the elevator according to FIG. 1 with the elevator cage and the counterweight and a 2:1 support means guidance in the center of an elevator shaft,

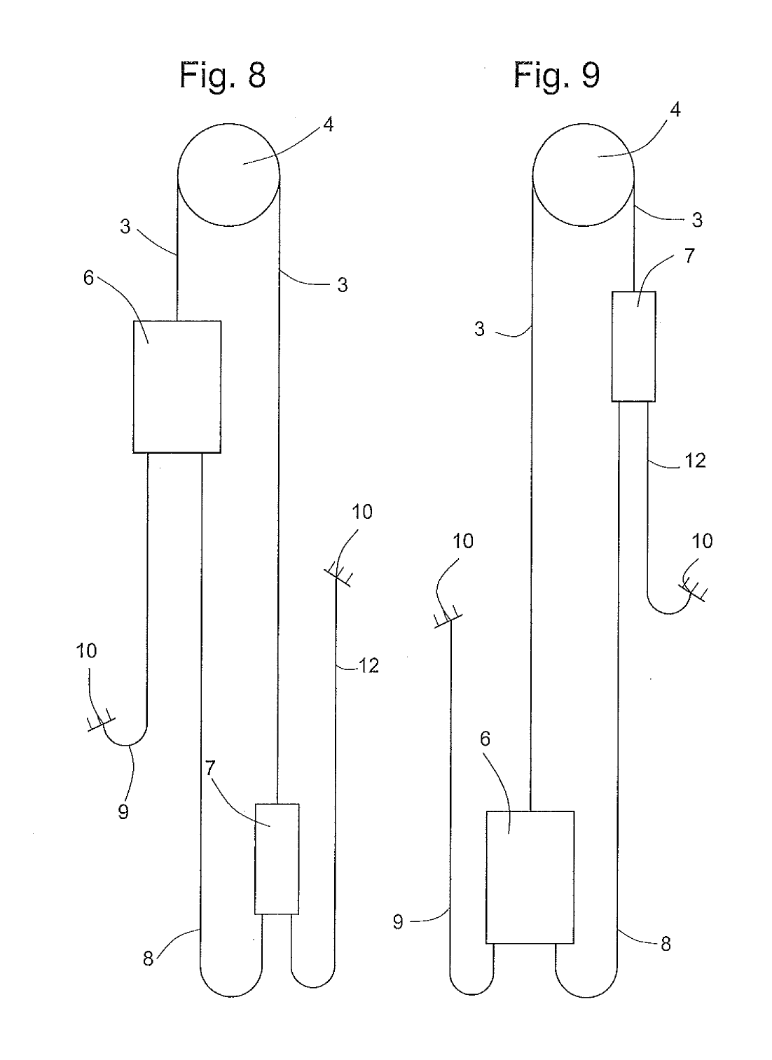

FIG. 6a shows the elevator according to FIG. 1 with the elevator cage at the bottom and the counterweight and a 2:1 support means guidance at the top of the elevator shaft,

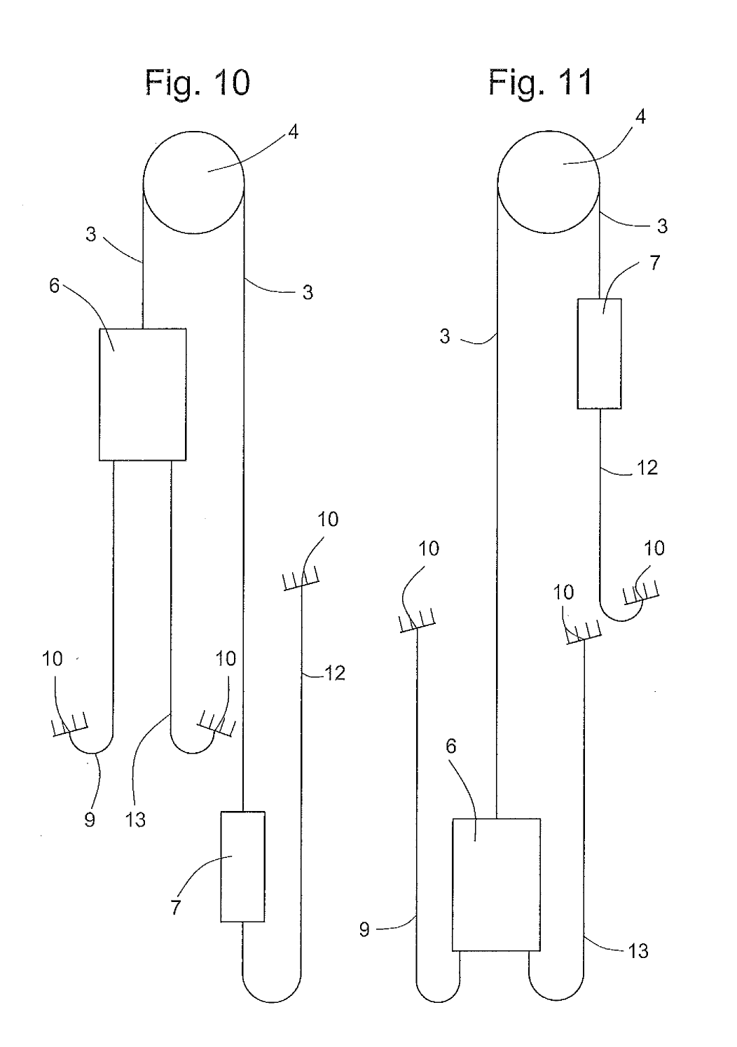

FIG. 7a shows the elevator according to FIG. 1 with the elevator cage at the top and the counterweight and a 2:1 support means guidance at the bottom of the elevator shaft,

FIGS. 8 and 9 show a variant of embodiment of the elevator according to FIG. 1, and

FIGS. 10 and 11 show a further variant of embodiment of the elevator according to FIG. 1.

### DETAILED DESCRIPTION

FIG. 1 shows an elevator 1 with equipment 2 for balancing the weight of a support means 3. The support means 3 is guided over a drive pulley 4, which in turn is drivable by means of an elevator drive (not illustrated). The support means 3 can be moved in two directions, symbolized by means of arrow P1, and is guided over a deflecting roller 5 which determines the cable run spacing SA. An elevator cage 6 is arranged at one end of the support means 3 and a counterweight 7 is arranged at the other end of the support means 3. The elevator cage 6 and the counterweight 7 are movable in opposite directions in an elevator shaft 10.1, which is illustrated in FIG. 4, by way of the support means 3, wherein the elevator cage 6 serves different stories.

The support means 3 can be, for example, at least one steel cable, at least one synthetic fiber cable, at least one flat belt, at least one wedge-ribbed belt, at least one V-belt, etc.

If the elevator cage 6 is at the top of the elevator shaft, the support means length and the weight of the support means 3 are large on the counterweight side (see FIG. 1). The weight of the support means 3 results from the support means length on the counterweight side and the support means weight per meter. If the elevator cage 6 is at the bottom of the elevator shaft, the support means length and the weight of the support means 3 is large on the cage side. A first balancing element 8 and a second balancing element 9 are provided as compensation for a resulting weight shift from the counterweight side to the cage side and conversely. The first balancing element 8 is arranged at one end at the elevator cage 6 and at the other end at the counterweight 7. The second balancing element 9 is arranged at one end at the elevator cage 6 and at the other end at a shaft wall 10. In one exemplifying embodiment the balancing element 9 is arranged at the shaft wall 10 at half the shaft height.

If, for example, the support means length of the support means 3 is large on the counterweight side, the balancing element length of the first balancing element 8 is small on the counterweight side and large on the cage side. In addition, the second balancing element 9 produces a weight compensation assisting the weight compensation of the first balancing element 8. Compensation for the weight shift on the part of the support means 3 is provided by the balancing elements 8, 9 acting in opposite sense. In one exemplifying embodiment an additional weight 7.1 can be arranged at the counterweight 7. The additional weight 7.1 in practice balances approximately half the weight of the second balancing element 9. Details with respect thereto are explained in FIGS. 5 to 8.

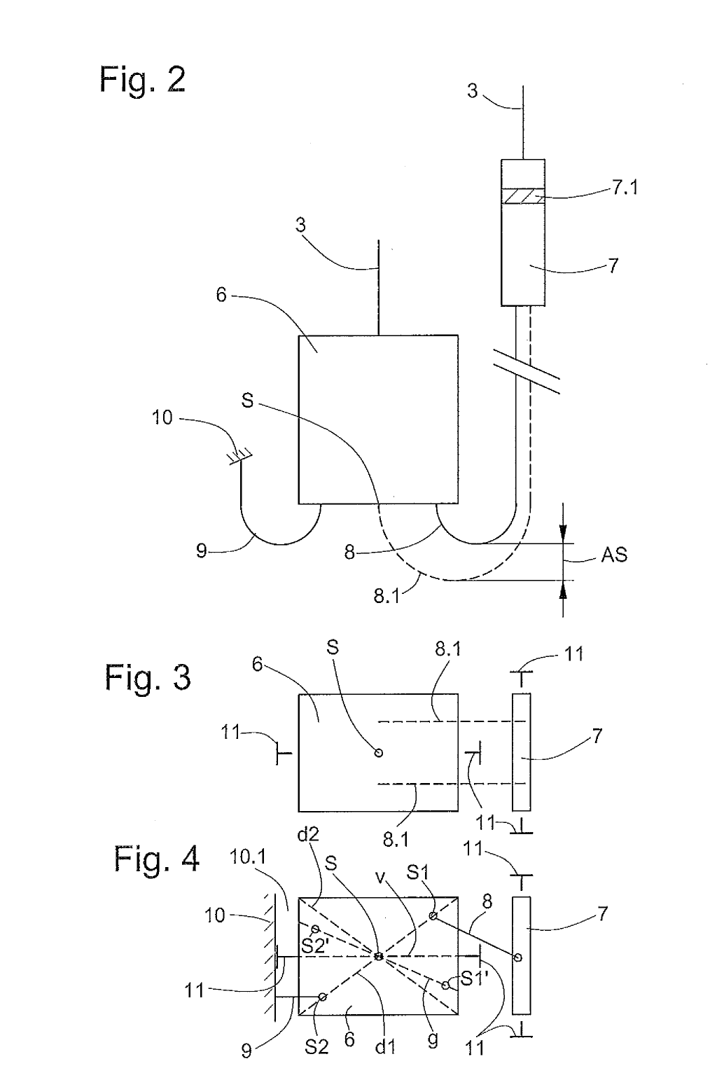

FIG. 2 shows a side view of the elevator cage 6 and the counterweight 7, with first and second balancing elements 8, 9 acting in symmetry with respect to the center of gravity S of the cage projection. A balancing element 8.1 acting at the center of gravity S, such as is known from the prior art and employed without the second balancing element 9, is shown by dashed lines. Also shown is how the much smaller loop radius of the first and second balancing elements 8, 9 impinges on the depth of the shaft pit. A loop spacing is denoted by AS and shows how with the proposed balancing elements 8, 9 the shaft pit depth is reduced. Details with respect thereto are explained in FIG. 4.

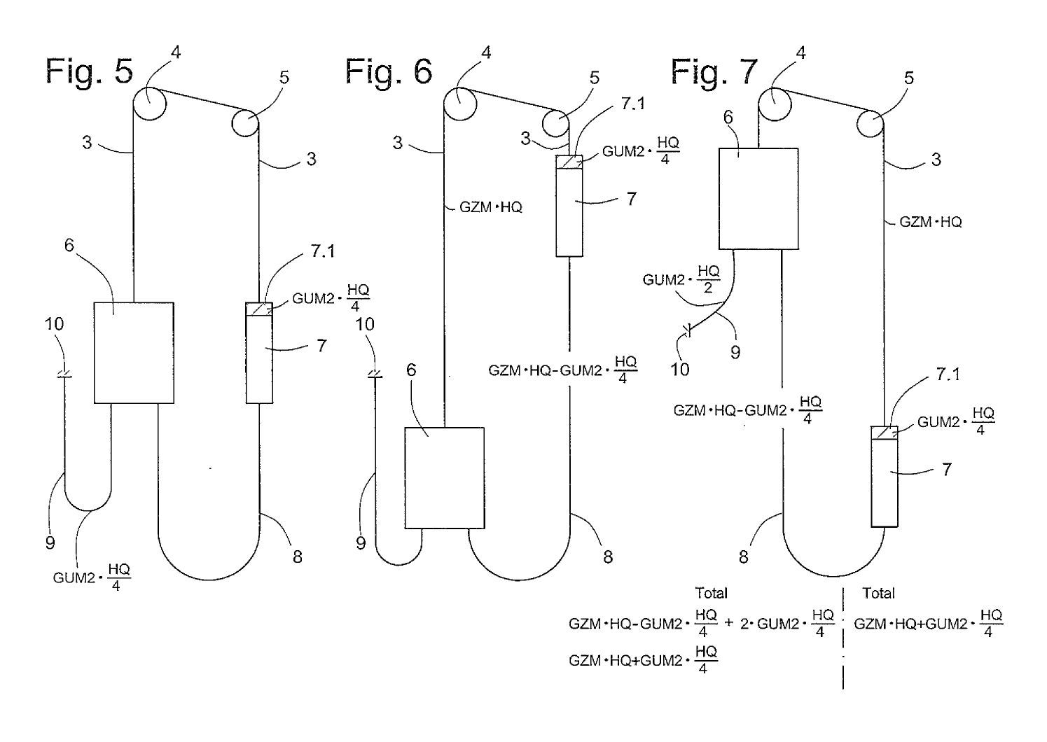

FIG. 3 shows a conventional, doubly constructed balancing element 8.1 as illustrated by dashed lines in FIG. 2. The two parallel guided balancing elements 8.1 act on the elevator cage symmetrically with respect to the centre of gravity S in the cage center. The illustrated points of action can be employed in this balancing element arrangement for reasons of cage balance.

FIG. 4 shows the elevator cage 6 and counterweight 7, which are guided in the elevator shaft 10.1 at guide rails 11, in projection with the proposed balancing elements 8, 9 according to FIG. 2. The balancing elements 8, 9 act generally at the edge of the cage projection in symmetry with respect to the center of gravity S on a first diagonal d1 of the projection at the elevator cage 8. The points of action S1, S2 can also lie on a second diagonal d2. The spacing of the point of action S1 from the counterweight 7 or the spacing of the point of action S2 from the shaft wall 10 can thereby be substantially reduced, and thus the loop radii are also substantially smaller. In some cases, for reasons of cage balance, the force acting in the first balancing element 8 should be of the same magnitude as the force acting in the second balancing element 9. The spacing of the point of action Si from the center of gravity S does not necessarily have to be same as the spacing of the point of action S2 from the center of gravity S. In that case, it can be important that the forces in the first balancing element 8 multiplied by the spacing from the center of gravity S are the same in terms of amount as the forces in the second balancing element 9 multiplied by the spacing from the center of gravity S.

The points of action S1 or S2 do not necessarily have to lie on one of the diagonals d1, d2. A straight line g, which runs through the center of gravity S and on which the points of action S1′, S2′ lie, is shown in FIG. 4. In at least some cases, the perpendicular spacing of the point of action S1′ from a straight line v, which connects the guide rails 11, multiplied by the forces in the first balancing element 8, has to be the same in terms of amount as the forces in the second balancing element 9 multiplied by the perpendicular spacing from the straight line v. In this manner the forces acting on the guide rails 11 can be minimized. In addition, the suspension cable acting, by way of example, at the point of action S2′ can be taken into consideration as a balancing element.

The weight ratios in the support means 3 and in the balancing elements 8, 9 are algebraically illustrated in FIGS. 5 to 7 and 5a to 7a by the following magnitudes:
GZM=weight per meter of the support means 3
GUM2=weight per meter of the second balancing element 9
I-IQ=conveying height,

FIG. 5 shows the elevator 1 according to FIG. 1 with the elevator cage 6 and the counterweight 7 in the center of the elevator shaft 10.1. The weight of the support means 3 is half on the cage side and half on the counterweight side. The weight of the first balancing means 8 is half on the cage side and half on the counterweight side. The additional weight 7.1 corresponds in practice with approximately half the weight of the second compensating element 9, the other weight half hanging at the shaft wall 10.

In FIG. 6 the elevator cage 6 is at the lower shaft end and the counterweight 7 at the upper shaft end. The second balancing element 9 has no effect on the elevator cage 6, the entire weight of the second balancing element 9 hanging at the shaft wall 10. The weight of the first balancing element 8 together with the additional weight 7.1 gives the weight of the support means 3. Compensation for the weight of the support means 3 is thus provided by the first balancing element 8 and by the additional weight 7.1.

In FIG. 7 the elevator cage 6 is at the upper shaft end and the counterweight 7 at the lower shaft end. The second balancing element 9 has full effect on the elevator cage 6, wherein the entire weight of the second balancing element 9 hangs at the elevator cage 6. The weight of the first balancing element 8 together with the weight of the second balancing element 9 gives the weight of the support means 3 and the weight of the additional weight 7.1. Compensation for the weight of the support means 3 and the additional weight 7.1 is thus provided by first and second balancing elements 8, 9.

FIG. 5a, FIG. 6a and FIG. 7a show the force relationships in the support means 3 and in the balancing elements 8 and 9 in the case of a 2:1 support means guidance. One end of the support means 3 is fastened to a first fixing point 3.1 and is guided over a first deflecting roller 6.1 of the elevator cage 6, and further over the drive pulley 4 and the deflecting roller 5, and further over a second deflecting roller 7.2 of the counterweight 7, wherein the other end of the support means 3 is fastened to a second fixing point 3.2. The force relationships are indicated in FIG. 5a by the elevator cage 6 at half conveying height, in FIG. 6a by the elevator cage at the bottom in the shaft and in FIG. 7a by the elevator cage 6 at the top in the shaft.

In the illustrated positions of the elevator cage 6 and the counterweight 7 of FIGS. 5 to 7 and FIGS. 5a to 7a, compensation for the support means weight is provided substantially fully by the compensating elements 8, 9 and by the additional weight 7.1.

In at least some embodiments, the force at the cage-side point of action S1 of the first balancing element 8 and the force at the cage-side point of action S2 of the second balancing element 9 are of the same size and the above-mentioned cage balance is achieved. In positions of the elevator cage 6 and the counterweight 7, which differ from the illustrated positions, in the elevator shaft 10.1 full balancing of the support means weight is not provided. In the case of upward and downward travel of the elevator cage 6 the balancing element length, and thus the weight of the second balancing element 9 effective with respect to balancing, change. However, the additional weight 7.1 does not change with different positions of the counterweight 7. The balancing accuracy, however, lies in the set percentage range and, in at least some cases, can be disregarded in practice.

FIGS. 8 and 9 show an exemplifying embodiment of the proposed equipment 2 for balancing the support means weight. A third balancing element 12 is provided instead of the additional weight 7.1. In FIG. 8 the first balancing element 8 and the second balancing element 9 balance the weight of the support means 3. The third balancing element 12 has, in the illustrated position of the elevator cage 6 at the upper shaft end and in the illustrated position of the counterweight 7 at the lower shaft end, no effect on the balancing, because the balancing element weight of the third balancing element 12 hangs at the shaft wall 10. The third balancing element 12 is arranged at one end at the shaft wall 10 substantially at half the shaft height and arranged at the other end at the projection of the counterweight 7. In FIG. 9 the third balancing element 12 and the first balancing element 8 balance the weight of the support means 3. The second balancing element 9 has, in the illustrated position of the elevator cage 6 at the lower shaft end and in the illustrated position of the counterweight 7 at the upper shaft end, no effect on the balance, because the balancing element weight of the second balancing element 9 hangs at the shaft wall 10.

FIG. 10 and FIG. 11 show a further exemplifying embodiment of the proposed equipment 2 for balancing the support means weight. A fourth balancing element 13 is provided instead of the first balancing element 8. In FIG. 10 the second balancing element 9 and the fourth balancing element 13 balance the weight of the support means 3. The third balancing element 12 has, in the illustrated position of the elevator cage 6 at the upper shaft end and in the illustrated position of the counterweight 7 at the lower shaft end, no effect on the balance. The fourth balancing element 13 is arranged at one end at the shaft wall 10 at substantially half the shaft height and at the other end at the projection of the elevator cage 6. In FIG. 11 the third balancing element 12 balances the weight of the support means 3 subject to the condition that the weight per meter of the third balancing element 12 generally corresponds with the weight per meter of the second balancing element 9 and the fourth balancing element 13 together. The second balancing element 9 and the fourth balancing element 13 have, in the illustrated position of the elevator cage 6 at the lower shaft end and in the illustrated position of the counterweight 7 at the upper shaft end, no effect on the balance.

In the variants of embodiment of FIGS. 8 to 11 the weight of the support means 3 is fully balanced independently of the position of the elevator cage 6 and the counterweight 7.

Cables, belts, chains or equivalent flexible elements, for example, can be used as balancing elements. Hanging cables with incorporated weights and with electrical conductors for power supply of the elevator cage 6 can also be used.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator comprising:
an elevator cage disposed in an elevator shaft;
a counterweight disposed in the elevator shaft;
a support coupled to the elevator cage and to the counterweight;
a plurality of balancing elements coupled to the elevator cage and configured to balance a weight of the support at a cage side of the elevator shaft or at a counterweight side of the elevator shaft; and
an additional weight coupled to the counterweight.

2. The elevator of claim 1, the plurality of balancing elements being coupled to the elevator cage at respective action points in a projection of the elevator cage, the respective action points being respective distances from a center of gravity of the elevator cage in the projection, and products of respective forces on the balancing elements and the respective distances being approximately equal.

3. The elevator of claim 2, the products being equal.

4. The elevator of claim 1, a first of the plurality of balancing elements being coupled to the elevator cage and to the counterweight, and a second of the plurality of balancing elements being coupled to the elevator cage and to a shaft wall of the elevator shaft.

5. The elevator of claim 4, the second of the plurality of balancing elements being coupled to the shaft wall at substantially halfway up the shaft wall.

6. The elevator of claim 4, the additional weight coupled to the counterweight having approximately half the weight of the second of the plurality of balancing elements.

7. An elevator comprising:
an elevator cage;
a counterweight;
a support that connects the elevator cage and the counterweight and moves them up and down in opposite directions in an elevator shaft;
balancing elements which balance the weight of the support at a cage side of the shaft or at a counterweight side of the shaft, wherein a plurality of balancing elements acts on the elevator cage; and
an additional weight provided at the counterweight.
